(19) United States
(12) Patent Application Publication
(10) Pub. No.: US 2010/0183843 A1
(43) Pub. Date: Jul. 22, 2010

(54) BIODEGRADABLE BIAXIALLY ORIENTED LAMINATED FILM

(76) Inventors: Sang II KIM, Suwon-si (KR); Kyung Yeon Kim, Suwon-shi (KR); Kweon Hyung Han, Suwon-si (KR)

Correspondence Address: SUGHRUE MION, PLLC, 2100 PENNSYLVANIA AVENUE, N.W., SUITE 800, WASHINGTON, DC, 20037, US

(21) Appl. No.: 12/670,060

(22) PCT Filed: May 28, 2008
(86) PCT No.: PCT/KR2008/002984

§ 371 Date: Jan. 21, 2010

(30) Foreign Application Priority Data
Jul. 23, 2007 (KR) 10-2007-0073433

(51) Int. Cl. B32B 5/16; B32B 27/36; B32B 5/00; B32B 7/02

(52) U.S. Cl. 428/143; 428/480; 428/220; 428/213

(57) ABSTRACT

A biodegradable biaxially oriented laminated film of the present invention comprising at least one first resin layer and at least one second resin layer which are alternately laminated together, the first and second resin layers containing as major components a polylactic acid-based polymer and an aromatic polyester-based resin, respectively, exhibits improved biodegradability, flexibility, gas-barrier property and heat-resistance, which is useful for environmentally friendly packaging.

### FIELD OF THE INVENTION

The present invention is directed to a biodegradable biaxially oriented laminated film having improved flexibility, gas-barrier property and heat-resistance, which is useful for environmentally friendly packaging.

### BACKGROUND OF THE INVENTION

Conventional plastic films such as cellophane, polyvinyl chloride, polyethylene, polypropylene, nylon and polyethylene terephthalate films have been widely employed for packaging. However, they are not completely satisfactory in terms of their performance characteristics.

For example, cellophane and polyvinyl chloride films generate toxic pollutants during the manufacturing and incinerating processes, and polyethylene films have been employed only for low-grade packaging materials due to their relatively poor heat-resistance and mechanical properties. Polypropylene, nylon and polyethylene terephthalate films, on the other hand, have satisfactory mechanical properties, but generate wastes that are not biodegradable. Further, although modified plastic films comprising a degradable material such as starch in an amount ranging from 20 to 40% have been reported, they have poor gas-barrier, heat-resistance and mechanical properties.

In order to solve such problems, there have been employed biodegradable aliphatic polyesters, particularly polylactic acid films. As such polylactic acid films are random copolymers of L-lactic acid and D-lactic acid, they are non-crystalline, and have poor heat-resistance and mechanical properties. Therefore, there have been developed techniques to render a polylactic acid film crystalline through incorporation of additives and also to enhance the heat-resistance thereof. However, the polylactic acid films produced using such techniques still suffer from the problems of poor gas-barrier property and flexibility, and they are not satisfactory for packaging.

### SUMMARY OF THE INVENTION

Accordingly, it is an object of the present invention to provide a biodegradable biaxially oriented laminated film having improved flexibility, gas-barrier property and heat-resistance which can be advantageously used for packaging.

In accordance with the present invention, there is provided a biodegradable biaxially oriented laminated film comprising at least one first resin layer and at least one second resin layer which are alternately laminated together, wherein:

the first and second resin layers contain as major components a polylactic acid-based polymer and an aromatic polyester-based resin, respectively; and

the laminated film has a coloring peak value of 0.4 or less, a dynamic frictional coefficient of 1.0 or less, and a biodegradability of 40% or more.

### DETAILED DESCRIPTION OF THE INVENTION

The laminated film in accordance with the present invention comprises at least one first resin layer consisted of a polylactic acid-based polymer or its copolymerization product with a small amount of other hydroxy carboxylic acid units.

The polylactic acid-based polymer used in the first resin layer has a melting temperature (Tₘ) of preferably 230° C. or less, more preferably 140 to 180° C. The hydroxy carboxylic acid unit may be glycolic acid or 2-hydroxy-3,3-dimethylbutylic acid and be used in an amount of 5% or less of the weight of the entire first resin layer.

The aromatic polyester-based resin used in the second resin layer may be prepared by polymerizing an acid component comprising an aromatic dicarboxylic acid as a major component with a glycol component comprising alkyleneglycol as a major component. Exemplery aromatic dicarboxylic acids include terephthalic acid, dimethyl terephthalate, isophthalic acid, dimethyl isophthalate, naphthalene-2,6-dicarboxylic acid, naphthalene-2,6-dicarboxylate derivatives and a mixture thereof. Exemplery alkyleneglycol includes ethyleneglycol, 1,3 -propanediol, tetramethyleneglycol, 1,4-cyclohexanedimethanol, neopentylglycol, 2-methyl-1,3-propanediol, diethyleneglycol and a mixture thereof.

The laminated film in accordance with the present invention may further comprise at least one third resin layer which is alternately laminated with the first and second resin layers, wherein the third resin layer comprises as a major component another aromatic polyester-based resin of which examples are listed above, but which is different from that used in the second resin layer.

The first, second and third resin layers of the inventive laminated film may further comprise other additives such as a polymerization catalyst, dispersant, electrostatic generator, anti-static agent, UV blocking agent, anti-blocking agent and inorganic lubricant to the extent they do not adversely affect the film properties.

The inventive laminated film may have a total thickness of 5 to 200 μm, preferably 9 to 50 μm, and be composed of 6 to 240 layers, preferably 10 to 200 layers. The total layer number of the film may be appropriately controlled within the above-mentioned range so as to meet the total thickness.

An average thickness of each of individual first and second resin layers may be in a range of 100 to 3,000 nm, preferably 200 to 2,000 nm. A lower value of the average thickness may be determined by an equation [λ/4n] (wherein, λ is the red-light wavelength, 780 nm, and n is a refractive index of an individual resin layer), depending on the kind of the used polylactic acid-based polymer or aromatic polyester-based resin constituting the individual resin layer. For example, when the first resin layer has the refractive index of 1.465, the lower value of the average thickness of the first resin layer becomes 133 nm.

In order to enhancing the overall biodegradability of the film, it is preferred that an outermost layer of the laminated film is the first resin layer, and that the average thickness of the second resin layer is smaller than that of the first resin layer.

The inventive laminated film may be prepared by a conventional method, for example, by melt-extruding each resin for forming the first and the second layers at a temperature higher than the melting point of the resin by about 30° C. using an extrusion die, alternately laminating the extrudates in a multi-feed block, cooling and biaxially drawing the laminate.

The inventive laminated film has a coloring peak value of 0.4 or less, preferably 0.3 or less, which is determined by the combination of a refractive index and an average thickness of an individual resin layer as an index showing the coloring degree of the film. Its lower value means a state close to colorlessness and transparency, and its higher value does a state stained or unnecessarily colored.

The inventive laminated film has a biodegradability of 40% or more, preferably 50 to 90%. In order to satisfy this requirement, the weight of the used first resin layers must be beyond 40% of the total weight of the film.

In addition, the inventive laminated film has a gas-permeability of 350 cc/m²/day·atm or less (based on 25 μm of the film thickness), a modulus of elasticity of 35Q kgf/mm² or less, and a heat shrinkage of 10% or less. In contrast, a conventional polylactic acid-based polymer film has a gas-permeability of about 1,000 cc/m²/day·atm, a modulus of elasticity of about 460 kgf/mm², and a heat shrinkage of about 15%, exhibiting extremely poor gas-barrier property and heat-resistance, and being too stiff due to lack of flexibility, which is not suitable for packaging.

Further, the inventive laminated film has a dynamic frictional coefficient of 1.0 or less. When the dynamic frictional coefficient of the film is larger than 1.0, its handling property in post-processing procedures including film-producing and printing steps deteriorates, which extremely reduces the film's production yield.

In the present invention, inert inorganic particles as an anti-static agent or anti-blocking agent may be added to or coated on a portion, in particular outermost layers, or all of the first resin layers of the laminated film to make the dynamic frictional coefficient of the film below 1.0. Representative examples of the inert inorganic particles include silicon dioxide, calcium carbonate, talc, kaoline, titanium dioxide and a mixture thereof, and among these, silicon dioxide is preferred. Also, it is desired that the inert inorganic particles have an average diameter of 0.05 to 5 μm and spherical or platy shapes. The inert inorganic particles may be used in an amount ranging from 0.0001 to 1.0% by weight based on the total weight of the film.

As described above, the inventive laminated film can be efficiently used as an environmentally friendly wrapping material due to its superior flexibility, gas-barrier property, heat-resistance and biodegradability.

The following Examples are given for the purpose of illustration only, and are not intended to limit the scope of the invention.

### Preparation Example 1

### Polymer (A)

95% by weight of the polylactic acid resin (Nature Works LLC, 4032D) having a melting temperature of 160° C. and 5% of a master batch resin prepared by dispersing silicon dioxide having an average particle size of 2 μm in the same polylactic acid resin were blended so that the silicon dioxide content of the resulting film became 0.05% by weight, which was designated as “Polymer (A)”. The film of Polymer (A) biaxially drawn according to the general method as the following Comparative Example 1 has the refractive index of 1.465.

### Preparation Example 2

### Polymer (B)

In an autoclave equipped with a stirrer and a distillation column, neopentylglycol and 1,3-propanediol were added to dimethyl terephthalate, wherein the amounts of neopentylglycol and 1,3-propanediol were 20 and 150 parts by mole, respectively, based on 100 parts by mole of the dimethyl terephthalate. Each of manganese acetate and tributylene titanate (TBT), ester exchange catalysts, was added to the mixture in the amount of 0.05% of the weight of the dimethyl terephthalate, which was slowly heated to 220° C. with the removal of methanol, to complete a desired ester exchange reaction. Just after the completion of the reaction, silicon dioxide having an average diameter of 2 μm and phosphoric acid as a heat stabilizer were sequentially added to the resulting product in respective amounts of 0.05% of the weight of the dimethyl terephthalate, and the mixture was stirred for 5 mins. 0.035% by weight of germanium oxide and 0.005% by weight of tetrabutylene titanate were added thereto, which was stirred for 10 mins. Then, the resulting product was allowed to be dropped to another reactor equipped with a condenser, heated to 285° C. while slowly vacuumed and be polymerized for 210 mins, to obtain “Polymer (B)” having an extreme viscosity of 0.64 and a melting temperature of 220°C. The film of Polymer (B) biaxially drawn according to the general method as the following Comparative Example 2 has the refractive index of 1.620.

### Preparation Example 3

### Polymer (C)

In an autoclave equipped with a stirrer and a distillation column, neopentylglycol and 1,3-propanediol were added to dimethyl terephthalate, wherein the amounts of neopentylglycol and 1,3-propanediol were 20 and 150 parts by mole, respectively, based on 100 parts by mole of the dimethyl terephthalate. Manganese acetate, an ester exchange catalyst, was added to the mixture in the amount of 0.07% of the weight of the dimethyl terephthalate, which was slowly heated to 220° C. with the removal of methanol, to complete a desired ester exchange reaction. Just after the completion of the reaction, silicon dioxide having an average diameter of 2 μm and phosphoric acid as a heat stabilizer were sequentially added to the resulting product in respective amounts of 0.05% of the weight of the dimethyl terephthalate, and the mixture was stirred for 5 mins. 0.035% by weight of germanium oxide and 0.005% by weight of tetrabutylene titanate were added thereto, which was stirred for 10 mins. Then, the resulting product was allowed to be dropped to another reactor equipped with a condenser, heated to 285° C. while slowly vacuumed and be polymerized for 210 mins, to obtain “Polymer (C)” having an extreme viscosity of 0.60 and a melting temperature of 205° C.

### Example 1

### Biaxially Oriented Laminated Film—(1)

Polymer A obtained in Preparation Example 1 was subjected to drying at 80° C. for 5 hrs, and Polymer B obtained in Preparation Example 2 was subjected to drying in order at 90° C. for 2 hrs and 120° C. for 3 hrs. Polymers A and B thus dried were melt-extruded at 225 and 260° C., respectively, diverged into 19 layers and 18 layers with the same thickness, respectively, and then alternately laminated in a thickness ratio of 2:1 in a multi-feed block. The resulting laminate was cooled by passing through a cooling roll maintained to 20° C., to obtain an undrawn laminate sheet of total 37 layers of which the outermost layers are composed of Polymer A. The sheet was quickly pre-heated to 65° C., drawn at a ratio of 3.5 in the longitudinal direction (LD) at 75° C. and drawn at a ratio of 3.5 in the transverse direction (TD) at 86° C., and then heat-set at 128° C. for 3 seconds, to obtain a biaxially oriented laminated film of 25 μm thickness and 37 layers.

### Example 2

### Biaxially Oriented Laminated Film—(2)

The procedure of Example 1 was repeated except that Polymers A and B were diverged into 23 layers and 22 layers, respectively, to obtain a biaxially oriented laminated film of 25 μm thickness and 45 layers.

### Example 3

### Biaxially Oriented Laminated Film—(3)

The procedure of Example 1 was repeated except that Polymer C obtained in Preparation Example 3 was used instead of Polymer B, to obtain a biaxially oriented laminated film of 25 μm thickness and 37 layers.

### Example 4

### Biaxially Oriented Laminated Film—(4)

The procedure of Example 1 was repeated except that the polylactic acid resin (Nature Works LLC, 4032D) having no silicon dioxide was used instead of Polymer A, and that the surfaces of the layers thereof were roll-coated with an aqueous solution containing 5% by weight of spherical silicon dioxide (an average particle size of 1.0 μm) in the solid content of 0.002% by weight, to obtain a biaxially oriented laminated film of 25 μm thickness and 37 layers.

### Comparative Example 1

### Biaxially Oriented and Monolayered Film—(1)

Polymer A obtained in Preparation Example 1 was subjected to drying at 80° C. for 5 hrs, melt-extruded at 225° C., and then cooled by passing through a cooling roll maintained to 20° C., to obtain an undrawn monolayered sheet. The sheet was quickly pre-heated to 65° C., drawn at a ratio of 3.5 in the longitudinal direction (LD) at 75° C. and drawn at a ratio of 3.5 in the transverse direction (TD) at 86° C., and then heat-set at 128° C. for 3 seconds, to obtain a biaxially oriented and monolayered film of 25 μm thickness.

### Comparative Example 2

### Biaxially Oriented and Monolayered Film—(2)

Polymer B obtained in Preparation Example 2 was subjected to drying in order at 90° C. for 2 hrs and 120° C. for 3 hrs, melt-extruded at 260° C., and then cooled by passing through a cooling roll maintained to 20° C., to obtain an undrawn monolayered sheet. The sheet was quickly pre-heated to 65° C., drawn at a ratio of 3.5 in the longitudinal direction (LD) at 75° C. and drawn at a ratio of 3.5 in the transverse direction (TD) at 86° C., and then heat-set at 128° C. for 3 seconds, to obtain a biaxially oriented and monolayered film of 25 μm thickness.

### Comparative Example 3

### Biaxially Oriented Laminated Film of 5 Layers

The procedure of Example 1 was repeated except that Polymers A and B were diverged into 3 layers and 2 layers, respectively, to obtain a biaxially oriented laminated film of 25 μm thickness and 5 layers.

### Comparative Example 4

### Biaxially Oriented Laminated Film of 241 Layers

The procedure of Example 1 was repeated except that Polymers A and B were diverged into 121 layers and 120 layers, respectively, to obtain a biaxially oriented laminated film of 25 μm thickness and 241 layers.

### Performance Test

The films obtained in Examples 1 through 4 and Comparative Examples 1 through 4 were each assessed for the following properties. The results are shown in Table 1.

### (1) Melting Temperature (Tₘ, ° C.)

Differential scanning calorimeter (Perkin-Elmer, DSC-7) analysis was performed at a temperature programming rate of 20° C./min. The melting temperature was determined from peaks in the heat absorption curve.

### (2) Coloring Peak Value

The absorbance of a film sample at an incident light wavelength of 400 to 780 nm was measured using UV-Visible Meter (Japan Shimazu, UV-265FW). The maximum absorbance value was designated as the coloring peak value.

### (3) Dynamic Frictional Coefficient (μk)

According to ASTM D1894, the dynamic frictional coefficient was determined as follows: a film sample was cut into a 15 mm (length)×15 mm (width) piece. 150 g of a clapper was put on the two pieces piled up and subjected to slip with the speed of 20 mm/min. The dynamic frictional coefficient was calculated by dividing the force generated at the slip with the force perpendicular to the frictional face.

### (4) Biodegradability (%)

The biodegradability of a film sample was evaluated according to KS M3100-1 (2003), and the ratio of biodegradability value of the film sample and that of a standard material over a period of 180 days was calculated according to the following equation:

$$Biodegradability ( \% ) = \frac{\begin{matrix}Biodegradability \\ of film sample\end{matrix}}{\begin{matrix}Biodegradability \\ of standard material\end{matrix}} \times 100$$

(5) Air-Permeability (cc/m²/day·atm)

The air-permeability of a film sample was evaluated using an oxygen-permeability measuring instrument (USA MOCON, model: OX-TRAM 2/21) according to ASTM D3985.

(6) Modulus of Elasticity (kgf/mm²)

The modulus of elasticity of a film sample was determined by measuring the modulus of elasticity in each of the longitudinal and transverse directions using UTM (Intron, model: 4206-001), and calculating an average value therefrom, according to ASTM D882.

### (7) Heat Shrinkage (%)

A film sample was cut into a 200 mm (length) x 15 mm (width) piece, maintained at 100° C. in a circulating air oven for 5 minutes, and the change in the film length was measured. Using the following equation, the degrees of shrinkage in the longitudinal and the transverse directions were calculated.

Heat shrinkage (%)=[(length before heat treatment−length after heat treatment)/length before heat treatment]×100

### (8) Refractive Index

The refractive index of a film sample was determined by measuring the refractive index in each of the longitudinal and transverse directions using an Abbe refractometer, and calculating an average value therefrom.

TABLE 1

| | | Unit | Ex. 1 | Ex. 2 | Ex. 3 | Ex. 4 | C.E. 1 | C.E. 2 | C.E. 3 | C.E. 4 |
|---|---|---|---|---|---|---|---|---|---|---|
| First | Resin | — | A | A | A | Polylactic | A | B | A | A |
| resin | | | | | | acid | | | | |
| layer | Silica | W % | 0.05 | 0.05 | 0.05 | 0.05 | 0.05 | 0.05 | 0.05 | 0.05 |
| | Number | — | 19 | 19 | 19 | 19 | 1 | 1 | 3 | 121 |
| | Thickness | nm | 877 | 877 | 877 | 877 | 25,000 | 25,000 | 5,000 | 103 |
| Second | Resin | — | B | B | B | B | — | — | B | B |
| resin | Silica | w % | 0.05 | 0.05 | 0.05 | 0.05 | — | — | 0.05 | 0.05 |
| layer | Number | — | 18 | 18 | 18 | 18 | — | — | 2 | 120 |
| | Thickness | nm | 463 | 463 | 463 | 463 | — | — | 5,000 | 104 |

| | | | | | | | | | |
|---|---|---|---|---|---|---|---|---|---|
| Total layer number | — | 37 | 45 | 37 | 37 | 1 | 1 | 5 | 241 |
| Total film thickness | μm | 25 | 25 | 25 | 25 | 25 | 25 | 25 | 25 |
| Biodegradability | % | 60 | 60 | 60 | 60 | 98 | 0 | 60 | 60 |
| Coloring peak value | — | 0.09 | 0.23 | 0.09 | 0.09 | 0 | 0 | 0.05 | 1.5 |
| Dynamic frictional | — | 0.4 | 0.4 | 0.4 | 0.5 | 0.4 | 0.4 | 0.4 | 0.4 |
| coefficient | | | | | | | | | |
| Gas-permeability | cc/m²/ | 170 | 130 | 170 | 170 | 1,000 | 110 | 410 | 130 |
| | day · atm | | | | | | | | |
| Modulus of elasticity | kgf/mm² | 290 | 275 | 290 | 290 | 460 | 360 | 420 | 270 |
| Heat shringkage | % | 3 | 3 | 3 | 3 | 15 | 3 | 11 | 3 |

As shown in Table 1, the inventive laminated films of Examples 1 to 4 show improved properties in terms of biodegradability, coloring peak value, dynamic frictional coefficient, gas-permeability, modulus of elasticity and heat-resistance, as compared with those of Comparative Examples 1 to 4.

While the invention has been described with respect to the above specific embodiments, it should be recognized that various modifications and changes may be made to the invention b_{y} those skilled in the art which also fall within the scope of the invention as defined by the appended claims.

What is claimed is:

1. A biodegradable biaxially oriented laminated film comprising at least one first resin layer and at least one second resin layer which are alternately laminated together, wherein:
the first and second resin layers contain as major components a polylactic acid-based polymer and an aromatic polyester-based resin, respectively; and
the laminated film has a coloring peak value of 0.4 or less, a dynamic frictional coefficient of 1.0 or less, and a biodegradability of 40% or more.

2. The biodegradable biaxially oriented laminated film of claim 1, which is a laminated film composed of 6 to 240 layers.

3. The biodegradable biaxially oriented laminated film of claim 1, which has a total thickness of 5 to 200 μm.

4. The biodegradable biaxially oriented laminated film of claim 1, wherein the first and second resin layers each has an average thickness ranging from 100 to 3,000 nm.

5. The biodegradable biaxially oriented laminated film of claim 1, wherein the second resin layer has an average thickness smaller than the first resin layer.

6. The biodegradable biaxially oriented laminated film of claim 1, which has a gas-permeability of 350 cc/m²/day·atm or less.

7. The biodegradable biaxially oriented laminated film of claim 1, which has a modulus of elasticity of 350 kgf/mm² or less.

8. The biodegradable biaxially oriented laminated film of claim 1, which has a heat shrinkage of 10% or less.

9. The biodegradable biaxially oriented laminated film of claim 1, wherein an outermost layer is the first resin layer.

10. The biodegradable biaxially oriented laminated film of claim 9, wherein the first resin layer has inert inorganic particles incorporated therein or coated thereon.

11. A wrapping material comprising the biodegradable biaxially oriented laminated film according to claim 1.
